(19) United States
(12) Patent Application Publication
(10) Pub. No.: US 2006/0230018 A1
(43) Pub. Date: Oct. 12, 2006

(54) Mahalanobis distance genetic algorithm (MDGA) method and system

(75) Inventors: Anthony J. Grichnik, Peoria, IL (US); Michael Seskin, Cardiff, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/101,556

(22) Filed: Apr. 8, 2005

(51) Int. Cl. G06F 17/30

(52) U.S. Cl. 707/2

(57) ABSTRACT

A computer-implemented method to provide a desired variable subset. The method may include obtaining a set of data records corresponding a plurality of variables and defining the data records as normal data or abnormal data based on predetermined criteria. The method may also include initializing a genetic algorithm with a subset of variables from the plurality of variables and calculating Mahalanobis distances of the normal data and the abnormal data based on the subset of variables. Further, the method may include identifying a desired subset of the plurality of variables by performing the genetic algorithm based on the Mahalanobis distances.

### TECHNICAL FIELD

This disclosure relates generally to computer based mathematical modeling techniques and, more particularly, to mathematical modeling methods and systems for identifying a desired variable subset.

### BACKGROUND

Mathematical modeling techniques are often used to build relationships among variables by using data records collected through experimentation, simulation, or physical measurement or other techniques. To create a mathematical model, potential variables may need to be identified after data records are obtained. The data records may then be analyzed to build relationships among identified variables. In certain situations, the number of data records may be limited by the number of systems that can be used to generate the data records. In these situations, the number of variables may be greater than the number of available data records, which creates so-called sparse data scenarios.

Conventional solutions, such as design of experiment (DOE) techniques, have been developed to identify variables and their interactions. The design of experiment technique may also use the concept of Mahalanobis distance, as described in Genichi et al., “The Mahalanobis Taguchi Strategy, A Pattern Technology System” (John Wiley & Sons, Inc., 2002). Genichi et al. illustrates a Mahalanobis-Taguchi strategy with methods for developing multidimensional measurement scales using measures and procedures that are data analytic and not dependent upon the distribution of the characteristics of systems under measurement. Such conventional solutions, however, often do not effectively address problems associated with sparse data scenarios.

Methods and systems consistent with certain features of the disclosed systems are directed to solving one or more of the problems set forth above.

### SUMMARY OF THE INVENTION

One aspect of the present disclosure includes a computer-implemented method to provide a desired variable subset. The method may include obtaining a set of data records corresponding to a plurality of variables and defining the data records as normal data or abnormal data based on predetermined criteria. The method may also include initializing a genetic algorithm with a subset of variables from the plurality of variables and calculating Mahalanobis distances of the normal data and the abnormal data based on the subset of variables. Further, the method may include identifying a desired subset of the plurality of variables by performing the genetic algorithm based on the Mahalanobis distances.

Another aspect of the present disclosure includes a computer-implemented method for defining normal data and abnormal data from a data set. The method may include obtaining two or more clusters by applying a clustering algorithm to the data set, determining a first cluster and a second cluster that have a largest difference in normalized means, and defining the first cluster as normal data and the second cluster as abnormal data.

Another aspect of the present disclosure includes a computer system. The computer system may include a console and at least one input device. The computer system may also include a central processing unit (CPU). The CPU may be configured to obtain a set of data records corresponding a plurality of variables, wherein a total number of the data records may be less than a total number of the plurality of variables. The CPU may be configured to define the data records as normal data or abnormal data based on predetermined criteria. The CPU may also be configured to further initialize a genetic algorithm with a subset of variables from the plurality of variables, calculate Mahalanobis distances of the normal data and the abnormal data based on the subset of variables, and identify a desired subset of the plurality of variables by performing the genetic algorithm based on the Mahalanobis distances.

Another aspect of the present disclosure includes a computer-readable medium for use on a computer system configured to perform a variable reducing procedure. The computer-readable medium may include computer-executable instructions for performing a method. The method may include obtaining a set of data records corresponding to a plurality of variables. The total number of the data records may be less than the total number of the plurality of variables. The method may also include defining the data records as normal data or abnormal data based on predetermined criteria and initializing a genetic algorithm with a subset of variables from the plurality of variables. The method may further include calculating Mahalanobis distances of the normal data and the abnormal data based on the subset of variables and identifying a desired subset of the plurality of variables by performing the genetic algorithm based on the Mahalanobis distances.

### BRIEF DESCRIPTION OF THE DRAWINGS

FIG. 1 illustrates a flowchart diagram of an exemplary data analyzing and processing flow consistent with certain disclosed embodiments;

FIG. 2 illustrates a block diagram of a computer system consistent with certain disclosed embodiments;

FIG. 3 illustrates a flowchart of an exemplary variable reducing process performed by the computer system;

FIG. 4 illustrates an exemplary relationship between the normal data, abnormal data, and corresponding Mahalanobis distances; and

FIG. 5 illustrates exemplary clusters of a data set consistent with disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

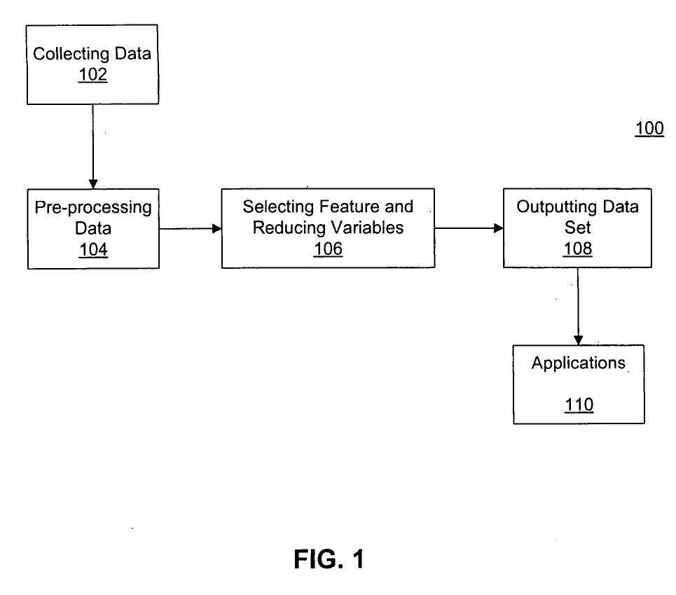

FIG. 1 illustrates a flowchart diagram of an exemplary data analyzing and processing flow 100 using Mahalanobis distance and incorporating certain disclosed embodiments. Mahalanobis distance may refer to a mathematical representation that may be used to measure data profiles such as learning curves, serial position effects, and group profiles based on correlations between variables in a data set. Different patterns can then be identified and analyzed. Mahalanobis distance differs from Euclidean distance in that Mahalanobis distance takes into account the correlations of the data set. Mahalanobis distance of a data set X (e.g., a multivariate vector) may be represented as
MDᵢ=(Xᵢ−μₓ)Σ⁻¹(Xᵢ−μₓ)′ (1)
where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated variables from separate data groups having different variances.

As shown in FIG. 1, data records or data sets may first be collected to identify potentially relevant variables (process 102). Data records may be collected by any appropriate type of method. For example, data records may be taken from actual products, specimens, services, and/or other physical entities. In certain embodiments, a sparse data scenario may arise. That is, the number of data records may be fewer than the number of potential relevant variables. Data records may then be pre-processed to remove obvious erroneous or inconsistent data records (process 104).

The pre-processed data may be provided to certain algorithms, such as a Mahalanobis distance genetic algorithm (MDGA), to reduce a large number of potential variables to a desired subset of variables (process 106). The reduced subset of variables may then be used to create accurate data models. The subset of variables may further be outputted to a data storage for later retrieval (process 108). The subset of variables may also be directly outputted to other application software programs to further analyze and/or model the data set (process 110). Application software programs may include any appropriate type of data processing software program. The processes explained above may be performed by one or more computer systems.

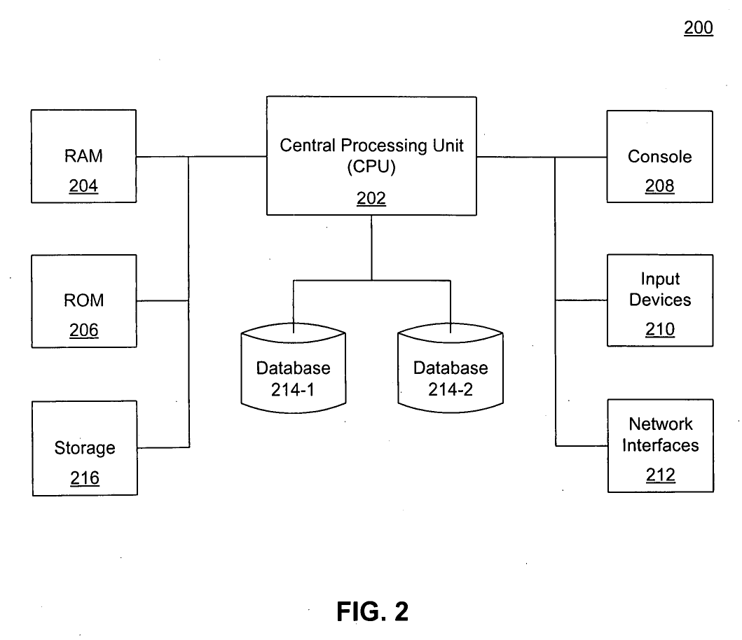

FIG. 2 shows a functional block diagram of an exemplary computer system performing these processes. As shown in FIG. 2, computer system 200 may include a central processing unit (CPU) 202, a random access memory (RAM) 204, a read-only memory (ROM) 206, a console 208, input devices 210, network interfaces 212, databases 214-1 and 214-2, and a storage 216. It is understood that the type and number of listed devices are exemplary only and not intended to be limiting. The number of listed devices may be varied and other devices may be added.

CPU 202 may execute sequences of computer program instructions to perform various processes as explained above. The computer program instructions may be loaded into RAM 204 for execution by CPU 202 from a read-only memory (ROM). Storage 216 may be any appropriate type of mass storage provided to store any type of information that CPU 202 may need to perform the processes. For example, storage 216 may include one or more hard disk devices, optical disk devices, or other storage devices to provide storage space.

Console 208 may provide a graphic user interface (GUI) to display information to users of computer system 200. Console 208 may be any appropriate type of computer display devices or computer monitors. Input devices 210 may be provided for users to input information into computer system 200. Input devices 210 may include a keyboard, a mouse, or other optical or wireless computer input devices. Further, network interfaces 212 may provide communication connections such that computer system 200 may be accessed remotely through computer networks.

Databases 214-1 and 214-2 may contain model data and any information related to data records under analysis, such as training and testing data. Databases 214-1 and 214-2 may also include analysis tools for analyzing the information in the databases. CPU 202 may use databases 214-1 and 214-2 to determine correlation between variables.

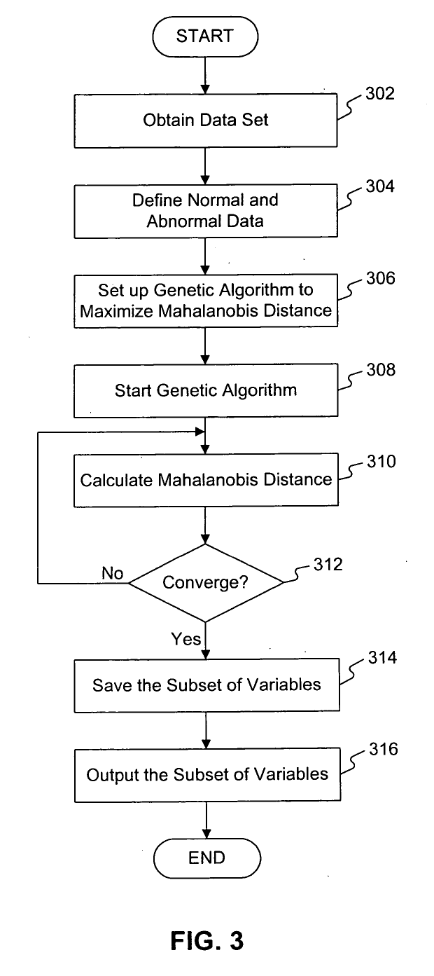

As explained above, computer system 200 may perform process 106 to select data set features and reduce variables. In certain embodiments, computer system 200 may use MDGA to perform process 106. FIG. 3 shows an exemplary flowchart of a variable reducing process included in process 106 that may be performed by computer system 200 and more specifically by CPU 202 of computer system 200.

As shown in FIG. 3, at the beginning of the variable reducing process, CPU 202 may obtain a data set corresponding to a set of variables (step 302). The data set may include data records pre-processed by other software programs. Alternatively, CPU 202 may obtain the data set directly from other software programs. After obtaining the data set, CPU 202 may define the data records as normal and abnormal data (step 304). Normal data may refer to data that satisfy certain predetermined standards. For example, normal data may include dimensional or functional characteristic data associated with a product manufactured within tolerance, performance characteristic data of a service process performed within tolerance, and/or any other characteristic data of any other products and processes. Normal data may also include characteristic data associated with design processes. On the other hand, abnormal data may refer to any characteristic data that may be out of tolerance and may need to be avoided or investigated. CPU 202 may define normal data and abnormal data based on deviation from target values, discreteness of events, allowable discrepancies, and/or whether the data is in distribution tails. In certain embodiments, normal data and abnormal data may be defined based on experts' opinions or empirical data in a corresponding technical field.

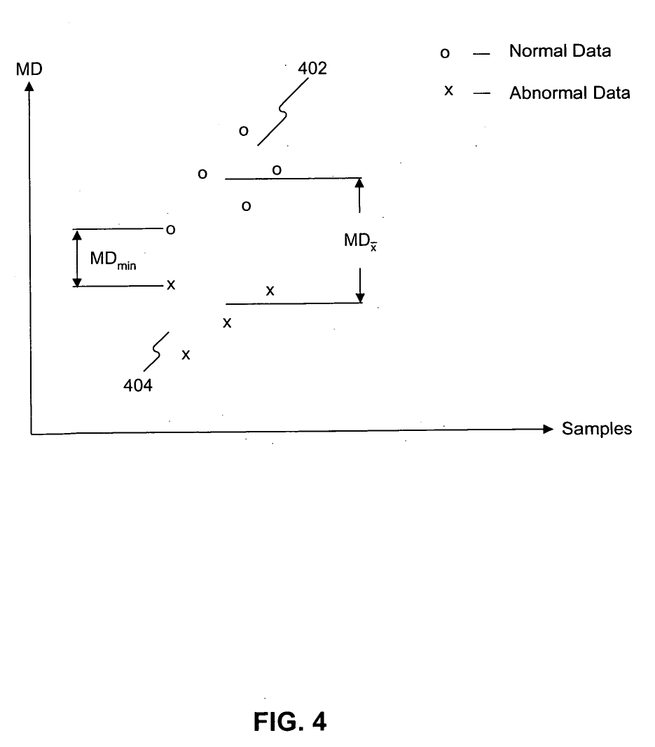

Normal data and abnormal data may be separated by Mahalanobis distances. An exemplary relationship between the normal data, abnormal data, and corresponding Mahalanobis distances is shown in FIG. 4. As shown in FIG. 4, normal data set 402 and abnormal data set 404 may be separated by Mahalanobis distances. A Mahalanobis distance MDₙₒᵣₘₐₗ may be calculated for normal data set 402, and a Mahalanobis distance MDₙₒᵣₘₐₗ may also be calculated for abnormal data set 404. A deviation or difference of Mahalanobis distance MDₓ between normal data set 402 and abnormal data set 404 may be determined by MDₓ=MD_{x,normal}−MD_{x,abnormal}, where x may refer to a particular set of variables of the data records. A mean Mahalanobis distance deviation MD_{\overline{x}} may be calculated by using a mean Mahalanobis distance of normal data set 402 and a mean Mahalanobis distance of abnormal data set 404 to evaluate overall deviation of Mahalanobis distance between normal data set 402 and abnormal data set 404. On the other hand, Mahalanobis distance MDₘᵢₙ may be calculated to indicate the closest Mahalanobis distance between normal data set 402 and abnormal data set 404.

Returning to FIG. 3, after defining a normal data set and an abnormal data set, CPU 202 may set up a genetic algorithm to be used in combination with Mahalanobis distance calculations (step 306). The genetic algorithm may be any appropriate type of genetic algorithm that may be used to find possible optimized solutions based on the principles of adopting evolutionary biology to computer science. When applying a genetic algorithm to search a desired subset of potential variables, the variables may be represented by a list of parameters used to drive an evaluation procedure of the genetic algorithm. The parameter list may be called a chromosome or a genome, which may represent an encoding of all variables, either selected or unselected. For example, a “0” encoding of a variable may indicate that the variable is not selected, while a “1” encoding of a variable may indicate that the variable is selected. Chromosomes may also include genes, each may be an encoding of an individual variable. Chromosomes or genomes may be implemented as strings of data and/or instructions.

Initially, several such parameter lists or chromosomes may be generated to create a population. A population may be a collection of a certain number of chromosomes. The chromosomes in the population may be evaluated based on a fitness function or a goal function, and a value of goodness or fitness may be returned by the fitness function or the goal function. The population may then be sorted, with those having better fitness ranked at the top.

The genetic algorithm may generate a second population from the sorted initial population by using any or all of the genetic operators, such as selection, crossover (or reproduction), and mutation. During selection, chromosomes in the population with fitness values below a predetermined threshold may be deleted. Selection methods, such as roulette wheel selection and/or tournament selection, may also be used. After selection, reproduction operation may be performed upon the selected chromosomes. Two selected chromosomes may be crossed over along a randomly selected crossover point. Two new child chromosomes may then be created and added to the population. The reproduction operation may be continued until the population size is restored. Once the population size is restored, mutation may be selectively performed on the population. Mutation may be performed on a randomly selected chromosome by, for example, randomly altering bits in the chromosome data structure.

Selection, reproduction, and mutation may result in a second generation population having chromosomes that are different from the initial generation. The average degree of fitness may be increased by this procedure for the second generation, since better fitted chromosomes from the first generation may be selected. This entire process may be repeated for any appropriate numbers of generations until the genetic algorithm converges. Convergence may be determined if the result of the genetic algorithm is improved during each generation and the rate of improvement reaches below a predetermined rate. The rate may be chosen depending on a particular application. For example, the rate may be set at approximately 1% for general applications and may be set at approximately 0.1% for more complex applications.

When CPU 202 sets up the genetic algorithm (step 306), CPU 202 may identify a maximum number of variables of a desired subset. As explained above, the data set may be a sparse data set, which may include more potential variables than total data records in the data set. In one embodiment, the maximum number may be less than or equal to the number of total data records in the data set. CPU 202 may set the maximum number as a constraint to chromosome encodings of the genetic algorithm.

CPU 202 may also set a goal function for the genetic algorithm to evaluate goodness or fitness of chromosomes. In certain embodiments, the goal function may include maximizing Mahalanobis distances between normal data set 402 and abnormal data set 404. The maximum deviation of Mahalanobis distance may be determined based on MD_{\overline{x}}, MDₘᵢₙ, or both, as described above. In operation, if the Mahalanobis distance deviation between normal data set 402 and abnormal data set 404 is above a predetermined threshold, the goal function may be satisfied. One or more values of the Mahalanobis distance deviation may also be returned by the goal function for further evaluations, such as convergence determination.

After setting up the genetic algorithm (step 306), CPU 202 may start the genetic algorithm (step 308). CPU 202 may choose an initial subset or subsets of variables or parameter lists for the genetic algorithm. CPU 202 may choose the initial subsets based on user inputs. Alternatively, CPU 202 may choose the initial subsets based on a correlation between potential variables and correlations between variables and results of applications 110. The correlation may depend on a particular application, such as a manufacturing, service, financial, and/or research application. For example, in a financial application including a unit variable, a price variable, and a weather variable, the unit variable and the price variable may be likely correlated. Only one of the unit variable and the price variable may be chosen to avoid redundancy; while the weather variable may be less likely correlated with the other two and may be also selected. However, if both the unit variable and the price variable correlate to a result of a financial application, for example, a total cost, both the unit variable and the price variable may be selected.

Further, alternatively, CPU 202 may cause the genetic algorithm to randomly select a subset or subsets of variables as initial chromosomes. A random seed used to randomly select the subset may be set by a user or by the genetic algorithm based on a predetermined configuration. CPU 202 may then calculate Mahalanobis distances for both normal and abnormal data based on the selected variable subset (step 310). The calculation may be performed by CPU 202 according to a series of steps related to equation 1. For example, CPU 202 may calculate descriptive statistics, calculate Z values, build a correlation matrix, invert the correlation matrix, calculate Z transpose, and calculate Mahalanobis distances.

After Mahalanobis distances (e.g., MDₙₒᵣₘₐₗ, MD_{abnormal}, MD_{\overline{x}}, and/or MDₘᵢₙ) have been calculated, the goal function may be evaluated. CPU 202 may further determine whether the genetic algorithm converges on the selected subset of variables (step 312). Depending on the types of applications, predetermined criteria may be used. For example, an improvement rate of approximately 0.1% may be used to determine whether the genetic algorithm converges. If the genetic algorithm does not converge on a particular subset (step 312; no), the genetic algorithm may proceed to create a next generation of chromosomes, as explained above. The variable reducing process goes to step 310 to recalculate Mahalanobis distances based on the newly created subset of variables or chromosomes. On the other hand, if the genetic algorithm converges with a particular subset (step 312; yes), CPU 202 may determine that a desired or optimized variable subset has been found.

CPU 202 may further save the optimized subset of variables with which the genetic algorithm converges as a result of the variable reducing process (step 314). CPU 202 may also save the subset in storage 216 for later retrieval or, alternatively, in database 214-1 and/or database 214-2. CPU 202 may also output the subset of variables to other application software programs for further processing or analysis (step 316).

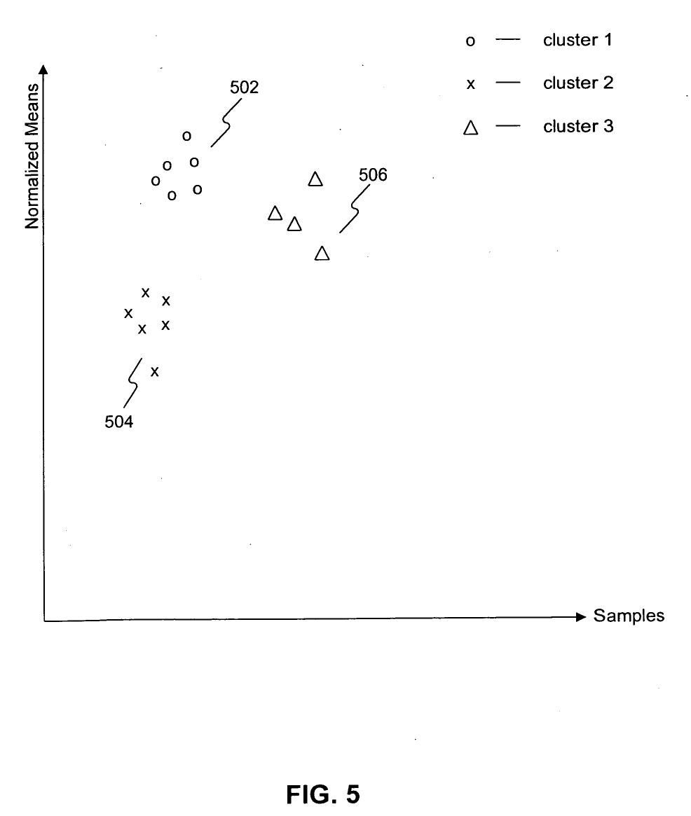

In certain embodiments, CPU 202 may also use a clustering algorithm to define the normal data set and abnormal data set, as described regarding step 304. The clustering algorithm may include any appropriate type of clustering algorithm, such as k-means, fuzzy k-means, nearest neighbor, kohonen networks, and/or adaptive resonance theory networks. In one embodiment, a k-means clustering algorithm with a “v-fold” cross-validation scheme may be used. At the beginning of defining the normal and abnormal data sets, CPU 202 may identify inherent data clusters (e.g., similar data or correlated data) of the data set. If only two clusters are identified, CPU 202 may use one cluster as the normal data set and use the other cluster as the abnormal data set. In certain situations, there may be more than two clusters identified. For example, CPU 202 may determine three, four, or even more clusters of the data set. FIG. 5 illustrates an exemplary data set with three clusters identified.

As shown in FIG. 5, clusters 502, 504, and 506 may be determined by CPU 202 after performing the clustering algorithm. CPU 202 may decide to identify the two clusters with the largest difference of normalized means as the normal data set and the abnormal data set (e.g., cluster 502 may represent the normal data set and cluster 504 may represent the abnormal data set). CPU 202 may further determine the difference of normalized means between cluster 502 and cluster 506, and the difference of normalized means between cluster 504 and cluster 506. By comparing these differences, CPU 202 may decide whether cluster 506 should be included in either the normal data set or the abnormal data set. For example, if the difference of normalized means between cluster 502 and cluster 506 is larger than the difference of normalized means between cluster 504 and cluster 506, CPU 202 may define cluster 506 as abnormal data. On the other hand, CPU 202 may define cluster 506 as normal data if the difference of normalized means between cluster 502 and cluster 506 is less than the difference of normalized means between cluster 504 and cluster 506.

Alternatively, CPU 202 may determine differences between each member of cluster 506 and cluster 502 and cluster 504. CPU 202 may then decide whether a particular member of cluster 506 should be defined as normal data or abnormal data based on the differences. Although three clusters are shown in FIG. 5, any number of clusters may be used.

Further, relationships among variables may also be identified during clustering algorithm operation, especially when more than two clusters are determined and individual members are decided to be included in one of the data set. Such relationship may be further provided by CPU 202 to the genetic algorithm to determine initial selection of a subset of variables. For example, if some variables may contribute significantly to the determination of the clusters, these variables may be likely included in the desired subset of variables and, thus, may be provided to seed the genetic algorithm population.

### INDUSTRIAL APPLICABILITY

The disclosed Mahalanobis distance genetic algorithm (MDGA) methods and systems may provide a desired solution for effectively reducing variables in sparse data scenarios, which may be difficult or impractical to be achieved by other conventional methods and systems. The disclosed methods and systems may be used to identify a desired subset of variables that can be used to create more accurate models. Performance of other statistical or artificial intelligence modeling tools may be significantly improved when incorporating the disclosed methods and systems.

The disclosed methods and systems may also be used to effectively reduce the dimensionality of a data set in which the number of dimensions or variables is larger than the possible number of actions that each variable may support. The disclosed methods and systems may reduce the dimensionality of a data set under various scenarios, such as sparse data scenarios, or scenarios in which the data is inverted, etc.

The disclosed methods and systems may also provide an option of using a clustering algorithm to define data characteristics. The disclosed clustering algorithm may effectively find desired data records to classify normal and abnormal data set without prior knowledge about the number of clusters. The combined clustered MDGA may provide additional functionality, such as the ability to search a candidate subset of variables for the most parsimonious solution that can quantitatively discriminate between different data records. Such data characteristics may be further provided to knowledge base modeling tools to increase operation speed of the modeling tools.

Other embodiments, features, aspects, and principles of the disclosed exemplary systems will be apparent to those skilled in the art and may be implemented in various environments not limited to work site environments.

What is claimed is:

1. A computer-implemented method for identifying a desired variable subset, comprising:
obtaining a set of data records corresponding to a plurality of variables;
defining the data records as normal data or abnormal data based on predetermined criteria;
initializing a genetic algorithm with a subset of variables from the plurality of variables;
calculating Mahalanobis distances of the normal data and the abnormal data based on the subset of variables; and
identifying a desired subset of the plurality of variables by performing the genetic algorithm based on the Mahalanobis distances.

2. The computer-implemented method according to claim 1, wherein a total number of the data records is less than a total number of the plurality of variables.

3. The computer-implemented method according to claim 1, further including:
outputting the desired subset to one or more application software programs.

4. The computer-implemented method according to claim 1, wherein defining includes:
defining the data records as normal data or abnormal data based on empirical data.

5. The computer-implemented method according to claim 1, wherein defining includes:
defining the data records as normal data or abnormal data based on one or more results from a clustering algorithm performed on the data records.

6. The computer-implemented method according to claim 1, wherein initializing includes:
randomly determining a subset of variables from the plurality of variables; and
providing a genetic algorithm with the determined subset of variables as an initial input vector.

7. The computer-implemented method according to claim 1, wherein initializing includes:
determining the subset of variables from the plurality of variables based on a correlation between the subset of variables; and
providing the genetic algorithm with the determined subset of variables as an initial input vector.

8. The computer-implemented method according to claim 1, wherein calculating Mahalanobis distances includes:
calculating a first Mahalanobis distance of the normal data based on the subset of variables;
calculating a second Mahalanobis distance of the abnormal data based on the subset of variables; and
determining a Mahalanobis distance deviation between the first Mahalanobis distance and the second Mahalanobis distance.

9. The computer-implemented method according to claim 8,
wherein identifying includes:
setting a goal function of the genetic algorithm to maximize the Mahalanobis distance deviation;
starting the genetic algorithm;
determining whether the genetic algorithm converges; and
identifying the subset of variables as a desired subset variable of the plurality of variables if the genetic algorithm converges.

10. The computer-implemented method according to claim 9,
wherein identifying further includes:
choosing a different subset of variables, based on the subset of variables and according to the genetic algorithm, if the genetic algorithm does not converge;
calculating a different Mahalanobis distance deviation based on the different subset of variables; and
performing the genetic algorithm to identify the desired subset of variables based on the different subset of variables.

11. A computer-implemented method for defining normal data and abnormal data from a data set, comprising:
obtaining two or more clusters by applying a clustering algorithm to the data set;
determining a first cluster and a second cluster that have a largest difference in normalized means; and
defining the first cluster as normal data and the second cluster as abnormal data.

12. The computer-implemented method according to claim 11, further including:
determining a first difference of normalized means between a third cluster and the first cluster;
determining a second difference of normalized means between the third cluster and the second cluster; and
defining the third cluster as normal data if the first difference is smaller than the second difference.

13. The computer-implemented method according to claim 12, further including:
defining the third cluster as abnormal data if the first difference is greater than the second difference.

14. The computer-implemented method according to claim 11, further including:
determining a first difference of normalized means between an individual member of a third cluster and the first cluster;
determining a second difference of normalized means between the individual member of the third cluster and the second cluster; and
defining the individual member as normal data or abnormal data based on the first and the second differences.

15. The computer-implemented method according to claim 11, further including:
providing the normal data and abnormal data to a Mahalanobis distance genetic algorithm (MDGA).

16. A computer system, comprising:
a console;
at least one input device; and
a central processing unit (CPU) configured to:
obtain a set of data records corresponding to a plurality of variables, wherein a total number of the data records is less than a total number of the plurality of variables;
define the data records as normal data or abnormal data based on predetermined criteria;
initialize a genetic algorithm with a subset of variables from the plurality of variables;
calculate Mahalanobis distances of the normal data and the abnormal data based on the subset of variables; and
identify a desired subset of the plurality of variables by performing the genetic algorithm based on the Mahalanobis distances.

17. The computer system according to claim 16, wherein, to define the data records, the CPU is configured to:
define the data records as normal data or abnormal data based on one or more results from a clustering algorithm performed on the data records.

18. The computer system according to claim 16, wherein, to calculate Mahalanobis distances, the CPU is configured to:
calculate a first Mahalanobis distance of the normal data based on the subset of variables;
calculate a second Mahalanobis distance of the abnormal data based on the subset of variables; and
determine a Mahalanobis distance deviation between the first Mahalanobis distance and the second Mahalanobis distance.

19. The computer system according to claim 18, wherein, to identify the desired subset, the CPU is configured to:
set a goal function of the genetic algorithm to maximize the Mahalanobis distance deviation;
start the genetic algorithm;
determine whether the genetic algorithm converges; and
identify the subset of variables as a desired subset variable of the plurality of variables if the genetic algorithm converges.

20. The computer system according to claim 19, wherein the CPU is further configured to:
choose a different subset of variables, based on the subset of variables and according to the genetic algorithm, if the genetic algorithm does not converge;
calculate a different Mahalanobis distance deviation based on the different subset of variables; and
perform the genetic algorithm to identify the desired subset of variables based on the different subset of variables.

21. The computer system according to claim 16, further including:
one or more databases; and
one or more network interfaces.

22. A computer-readable medium for use on a computer system configured to perform a variable reducing procedure, the computer-readable medium having computer-executable instructions for performing a method comprising:
obtaining a set of data records corresponding to a plurality of variables, wherein a total number of the data records is less than a total number of the plurality of variables;
defining the data records as normal data or abnormal data based on predetermined criteria;
initializing a genetic algorithm with a subset of variables from the plurality of variables;
calculating Mahalanobis distances of the normal data and the abnormal data based on the subset of variables; and
identifying a desired subset of the plurality of variables by performing the genetic algorithm based on the Mahalanobis distances.

23. The computer-readable medium according to claim 22, wherein the method further includes:
outputting the desired subset to one or more application software programs.

24. The computer-readable medium according to claim 22, wherein defining includes:
defining the data records as normal data or abnormal data based on one or more results from a clustering algorithm performed on the data records.

25. The computer-readable medium according to claim 22, wherein initializing includes:
randomly determining a subset of variables from the plurality of variables; and
providing a genetic algorithm with the determined subset of variables as an initial input vector.

26. The computer-readable medium according to claim 22, wherein initializing includes:
determining the subset of variables from the plurality of variables based on a correlation between the subset of variables; and
providing the genetic algorithm with the determined subset of variables as an initial input vector.

27. The computer-readable medium according to claim 22, wherein calculating Mahalanobis distances includes:
calculating a first Mahalanobis distance of the normal data based on the subset of variables;
calculating a second Mahalanobis distance of the abnormal data based on the subset of variables; and
determining a Mahalanobis distance deviation between the first Mahalanobis distance and the second Mahalanobis distance.

28. The computer-readable medium according to claim 22, wherein identifying includes:
setting a goal function of the genetic algorithm to maximize the Mahalanobis distance deviation;
starting the genetic algorithm;
determining whether the genetic algorithm converges; and
identifying the subset of variables as a desired subset variable of the plurality of variables if the genetic algorithm converges.

29. The computer-readable medium according to claim 28, wherein identifying further includes:
choosing a different subset of variables, based on the subset of variables and according to the genetic algorithm, if the genetic algorithm does not converge;
calculating a different Mahalanobis distance deviation based on the different subset of variables; and
performing the genetic algorithm to identify the desired subset of variables based on the different subset of variables.
